(19) United States
(12) Patent Application Publication
(10) Pub. No.: US 2017/0270489 A1
(43) Pub. Date: Sep. 21, 2017

(54) IDENTIFICATION AND TEST SUPPORT DEVICE AND METHOD

(71) Applicant: Robert Bosch GmbH, Stuttgart (DE)

(72) Inventor: Michael Dornhausen, Markgroeningen (DE)

(21) Appl. No.: 15/532,150

(22) PCT Filed: Oct. 27, 2015
(86) PCT No.: PCT/EP2015/074885

§ 371 Date: Jun. 1, 2017

(30) Foreign Application Priority Data
Dec. 15, 2014 (DE) 10 2014 225 937.1

(51) Int. Cl. G06Q 10/00; G02B 27/01; H04N 7/18; G07C 5/08; G07C 5/00

(52) U.S. Cl. CPC G06Q 10/20; G07C 5/085; G07C 5/006; H04N 7/181; G02B 27/0172; G02B 2027/0138

(57) ABSTRACT

An identification and test support device for identifying vehicle components and for supporting a motor vehicle test sequence, includes an identification and data processing unit designed to assign image data of an image signal to a respectively associated data record of the memory unit check the image data of the image signal received by the image signal receiver unit for adherence to the criteria stored in the associated data record and to transmit to a display unit the result of this check and/or the possible weak points of the respective vehicle component contained in the associated data record and/or the test steps to be performed for the respective vehicle component contained in the associated data record.

### FIELD

The present invention relates to an identification and test support device, in particular for identifying vehicle components and for supporting a motor vehicle test sequence as well as to a method for identifying vehicle components and for supporting a motor vehicle test sequence.

### BACKGROUND INFORMATION

Motor vehicles are subjected to regular tests. Thus, manufacturers recommend performing so-called service inspections in motor vehicle repair shops after a certain number of driven kilometers or after a certain time. In various countries throughout the world, roadworthiness tests are required by law at certain intervals. In Germany, so-called TÜV inspections are prescribed, which are conducted by authorized testing organizations.

The quality of such vehicle inspections still depends to a great extent on the knowledge and the experience of the respective motor vehicle mechanic or the respective inspector performing the inspection. While this knowledge and this experience frequently exists and can be built up quite quickly in specialized repair shops, in which normally motor vehicles of one or few automobile makes are tested, this is significantly more difficult in the case of independent repair shops and in testing organizations, in which motor vehicles of a great variety of makes are tested.

### SUMMARY

It is an objective of the present invention to provide a device and a method which are able to improve the quality of the motor vehicle test and which are able to lend support to the mechanic or tester for the test sequence to be performed that makes it possible to perform the test sequence more effectively and to detect faulty vehicle components more quickly and reliably.

An example identification and test support device of the present invention, in particular for identifying vehicle components and for supporting a motor vehicle test sequence, includes:

an image signal receiver unit that is designed to receive an image signal from at least one image signal source, the image signal containing image data of at least one vehicle component;

an image processing unit that is designed to ascertain the type of the vehicle component from the image data of an image signal received by the image signal receiver unit;

a memory unit, in which data records are stored that include data records for a multitude of motor vehicle types, which contain for a multitude of vehicle components respectively relevant component information such as criteria to be met by the respective vehicle components, possible weak points of the respective vehicle component, or test steps to be performed for the vehicle component; and

an identification and data processing unit that is designed to assign the image data of the image signal received by the image signal receiver unit to the respectively associated data record of the memory unit;

the identification and data processing unit being furthermore designed to check the image data of the image signal received by the image signal receiver unit for adherence to the criteria stored in the associated data record and to transmit to a display unit the result of this check and/or the possible weak points of the respective vehicle component contained in the associated data record or the test steps to be performed for the respective vehicle component contained in the associated data record.

An example method of the present invention for identifying vehicle components and for supporting a motor vehicle test sequence includes the following steps:

receiving an image signal from at least one image signal source by an image signal receiver unit, in particular by a camera of a pair of smart glasses, the image signal containing image data of at least one vehicle component;

ascertaining the type of the vehicle component from the image data of the image signal received by the image signal receiver unit by an image processing unit;

assigning the image data of the image signal received by the image signal receiver unit to a respectively associated data record of a memory unit by an identification and data processing unit, data records being stored in the memory unit that include data records for a multitude of motor vehicle types, which contain for a multitude of vehicle components respectively relevant component information such as criteria to be met by the respective vehicle component, possible weak point of the respective vehicle component, or test steps to be performed for the vehicle component; and

checking the image data of the image signal received by the image signal receiving unit by the identification and data processing unit for adherence to the criteria stored in the associated data record and transmitting the result of this check and/or the possible weak points of the respective vehicle component contained in the associated data record or the test steps to be performed for the respective vehicle components, which are contained in the associated data record, to a display unit, in particular to a display unit on the glasses of the pair of smart glasses.

According to the present invention, the motor vehicle mechanic or the motor vehicle tester is provided with valuable support for detecting the vehicle-specific weak points more quickly and more reliably and for missing fewer weak points.

Below, in place of the terms “motor vehicle mechanic or motor vehicle tester,” the term tester will be used.

The image processing unit, which may also be called an image detection unit, automatically and independently detects the type of the observed vehicle components from the image data of an image signal received by the image signal receiver unit.

The identification and data processing unit checks the image data for adherence to the criteria stored in the associated data record and the result of this check, for example the result “observed motor vehicle component acceptable/unacceptable” is transmitted to a display unit for display.

By assigning the image signal received by the image signal receiver unit to the respectively associated data record stored in the memory unit, relevant stored information is automatically provided to the tester in that the possible weak points contained in the data record associated with the image data and/or the test steps to be performed for the respective vehicle component are transmitted to a display unit for display.

According to the present invention, the observed vehicle component is thus automatically detected and checked for adherence to the relevant criteria, for example with respect to whether inadmissible modifications were made to this vehicle component or whether a vehicle component was installed that is inadmissible for the respective motor vehicle. The result is communicated automatically to the tester. Furthermore, the weak points frequently occurring for the respective vehicle component and the test points to be performed are automatically indicated to the tester.

This shortens the time required for the motor vehicle test sequence and thus results in lower costs. Furthermore, the test results are more precise, better and readily reproducible.

A vehicle component may be any vehicle component or any vehicle component group.

In one specific embodiment of the present invention, the identification and test support device furthermore includes a pair of smart glasses, which comprise the image signal receiver unit and the display unit. This makes it possible for the tester to perform the test sequence quickly and effectively without having to look away from the motor vehicle to be tested and in particular from the vehicle component to be tested. For this purpose, the image signal receiver unit is designed in particular as at least one digital camera. The digital camera is mounted in particular on the smart glasses, oriented forward in the direction of view of the tester and provides the image on the display unit in the tester's direction of view. The image signal picked up by this image signal receiver unit is automatically displayed on the display unit of the smart glasses, which is developed in particular in the form of visual fields that take up the space of the eye glasses of the smart glasses. The result of the test performed by the identification and data processing unit and/or the possible weak points of the respective vehicle component contained in the associated data record or the test steps to be performed for the respective vehicle component contained in the associated data record may be additionally displayed in the smart glasses.

According to an alternative specific embodiment, the image signal receiver unit is developed in the form of at least one permanently installed camera, and the display unit is developed in the form of at least one permanently installed or portable screen, for example a monitor, a tablet PC or a smart phone.

According to another specific embodiment, the identification and test support device includes at least one input device, in particular a touch screen and/or a voice input device and/or a gesture detection. In the event that a touch screen is provided as input device, this may be used both as input device and as display device.

According to another specific embodiment, a user is able to operate and control the identification and test support device via the input device. Such an input device enables the tester to influence the test sequence directly.

According to another specific embodiment, a user is able to input an evaluation of the respective vehicle component via the input device. This makes it possible to process and store an evaluation result ascertained by the tester.

According to another specific embodiment, the identification and test support device is furthermore designed in such a way that it is possible to produce a test report on the basis of at least one evaluation submitted by a user via the input device. Advantageously, this test report may also contain the test results of the respective vehicle components performed by the identification and data processing unit.

This makes it possible to produce a test report in automated fashion, which may contain both user inputs as well as test results ascertained by the identification and data processing unit.

According to another specific embodiment, the identification and test support device may furthermore include a database, in which evaluations or test reports submitted by a user via the input device may be stored. This makes it possible to utilize such evaluations and test reports for preparing evaluations and statistical analyses about the respective motor vehicles and motor vehicle components.

According to another specific embodiment, a user is able to input vehicle specifications such as the make, the type, the year of manufacture and the vehicle code via the input device. This facilitates the assignment of the correct data records, which contain the respectively relevant component information, to the image signals and yields more precise results.

In another specific embodiment, the identification and test support device is designed so as to enable gesture detection in that the image signal receiver unit and the image processing unit are able to determine at least one position of at least one body part of a user and compare this to stored position patterns, and in that it is possible to select the specific stored position pattern that exhibits the greatest agreement with the at least one detected position and to perform the action associated with the position pattern thus determined. Such a gesture detection is able to simplify the test sequence further because the user is able to perform such control action without turning his concentration and his gaze away from the respectively observed vehicle component.

According to another specific embodiment, the identification and test support device is furthermore designed in such a way that it is possible to ascertain from the image data of an image signal received by the image signal receiver unit, which contain at least one vehicle-identifying vehicle component or a total view of the vehicle, vehicle specifications such as the make, the type, the year of manufacture and the vehicle code, by comparison with stored data records. By ascertaining the vehicle specifications in this way it is possible to ensure that the correct data record from the memory unit is assigned to the vehicle components.

The advantages and specific embodiments described above concern both the identification and test support device of the present invention as well as the method of the present invention for identifying vehicle components and for supporting a vehicle test sequence. The applicant herein expressly reserves the right to direct dependent method claims to such specific embodiments.

### BRIEF DESCRIPTION OF THE DRAWINGS

The present invention is described in more detail belw on the basis of the figures.

FIG. 1 shows a schematic representation of an identification and test support device according to an exemplary embodiment of the present invention.

FIG. 2 shows a schematic representation of an exemplary test situation in a test sequence of a motor vehicle.

### DETAILED DESCRIPTION OF EXAMPLE EMBODIMENTS

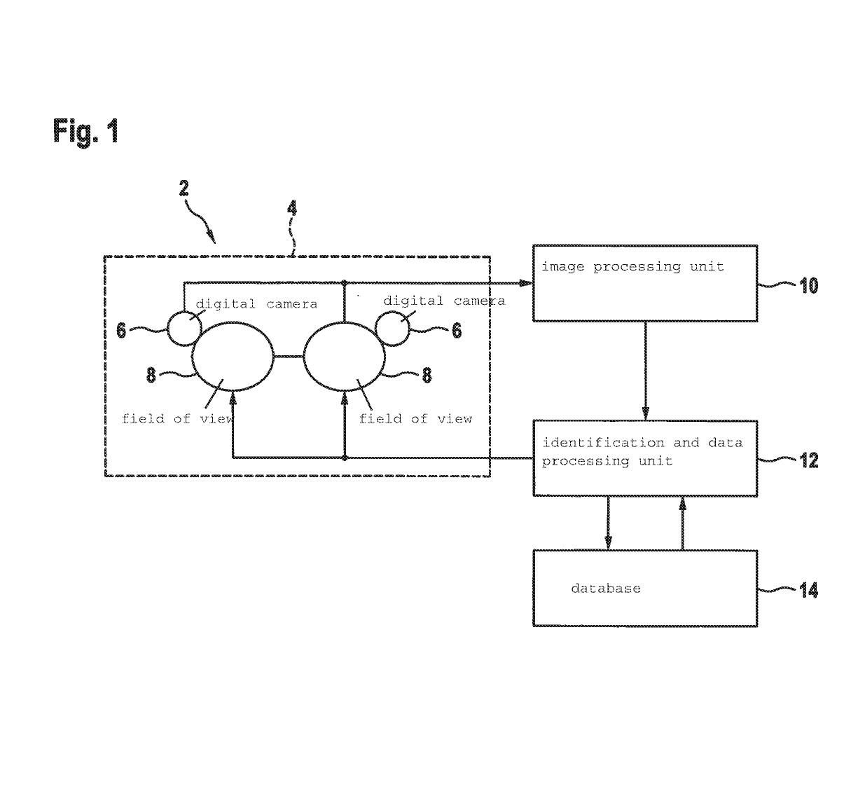

The identification and test support device 2 shown in FIG. 1 includes a pair of smart glasses 4 having digital cameras 6 attached to the smart glasses, which are directed in a direction of view of the tester, as well as fields of view 8, on which the image recorded by digital cameras 6 or the images recorded by digital cameras 6 is/are displayed or projected.

In addition, as will be explained below, it is possible to represent additional information on fields of view 8.

Identification and test support device 2 furthermore includes an image processing unit 10, an identification and data processing unit 12 having an integrated memory unit and a database 14, which is preferably situated in a stationary manner in a motor vehicle workshop or a motor vehicle test station.

Image processing unit 10 is connected to digital cameras 6 via suitable data connections, in particular via a wireless data connection, and is connected to identification and data processing unit 12 via another data connection, in particular via a wire-bound data connection.

Identification and data processing unit 12 is connected via a data connection, in particular via a wireless data connection, to smart glasses 4 in such away that it is possible to display the information produced by identification and data processing unit 12 on the fields of view 8 of smart glasses 4.

Furthermore, identification and data processing unit 12 is connected to database 14 via a data connection, in particular via a wire-bound data connection.

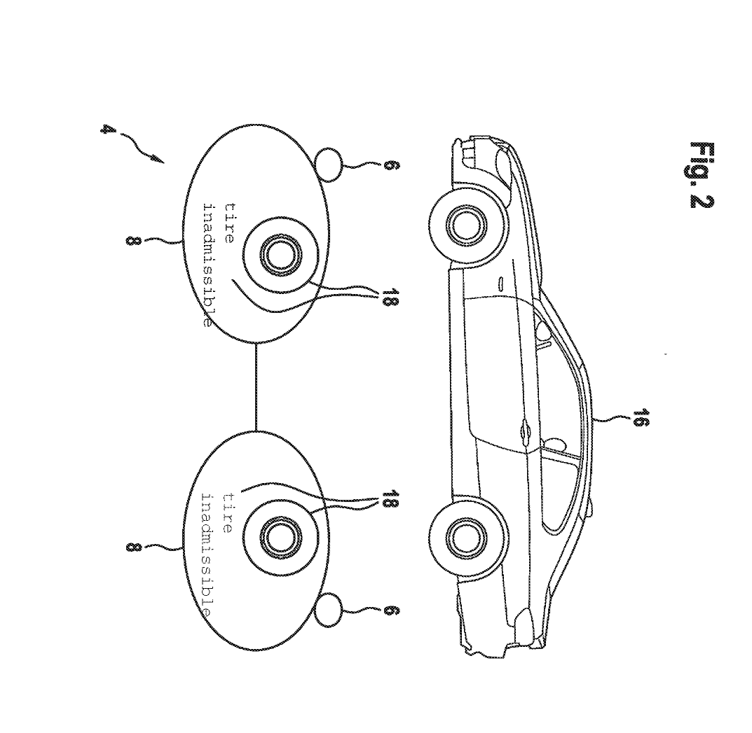

FIG. 2 shows an exemplary schematic representation of a test situation in a test sequence of a motor vehicle 16, on the basis of which the functionality of the identification and test support device 2 is explained.

FIG. 2 shows a motor vehicle 16 to be tested, and smart glasses 4 are directed toward a vehicle component, one of the wheels of motor vehicle 16, which includes a rim and a tire, having been selected for this purpose by way of example. The image of the vehicle wheel recorded by digital cameras 6 and a test result “tire inadmissible” produced by identification and data processing unit 12 are displayed on fields of view 8 of smart glasses 4 as display 18.

At the outset, the tester inspecting vehicle 16 puts on smart glasses 4 and communicates to identification and data processing unit 12 the identity of the motor vehicle 16 to be tested. Via a suitable input device, in particular a touch screen or a voice input device or a gesture detection, which are presently not shown for the sake of simplicity, the tester inputs the vehicle specifications such as the make, the type, year of manufacture and vehicle code.

Then the tester observes a component or a component group of motor vehicle 16, which may also be called vehicle components. In the present case, the tester first observes a wheel of motor vehicle 16. The image of this wheel recorded by digital cameras 6 is displayed in fields of view 8 of smart glasses 4. An image signal containing the image data of this motor vehicle wheel is transmitted by digital cameras 6 to image processing and detection unit 10, which ascertains from these image data by image detection and comparison with stored image data records the type of vehicle component, that is, which determines that it is a vehicle wheel including rim and tire.

The image data of the image signal are transmitted together with the information “vehicle component is vehicle wheel including rim and tire” to identification and data processing unit 12. The latter assigns this information to the associated data record “vehicle wheel for the motor vehicle to be tested,” which contains relevant component information, in particular the criteria to be met by the vehicle wheel, possible weak points of the vehicle wheel or test steps to be performed for the vehicle wheel.

Identification and data processing unit 12 subsequently checks the image data for adherence to the criteria stored in the associated data record. In the present case, identification and data processing unit 12 compares, e.g., the tire width of the image signal with the admissible tire width stored in the associated data record and determines that the tire width in the image signal is greater than the admissible limit value for the tire width stored in the data record.

Identification and data processing unit 12 thus outputs the test result “tire inadmissible” in the form of a signal to smart glasses 4, which represent this information on fields of view 8 in addition to the image of the vehicle wheel.

Furthermore, identification and data processing unit 12 is able to transmit additional information stored in the associated data record such as possible weak points of the vehicle wheel or test steps to be performed for the vehicle wheel to smart glasses 4 and display these there on fields of view 8, which is not shown in FIG. 2.

The result “tire inadmissible” is detected by identification and data processing unit 12 and may be stored in database 14, e.g., as part of a test or assessment report.

By gestures, which are detected via digital cameras 6 and image processing and detection unit 10, the tester himself is also able to output an evaluation of the vehicle components or generally operate identification and test support device 2.

Following the conclusion of the test of the vehicle component “vehicle wheel,” it is possible to proceed with testing the next vehicle component.

As an alternative to the smart glasses 4 shown in the present exemplary embodiment, it is also possible to use permanently installed cameras as image signal receiver units and permanently installed screens as display units.

Likewise, instead of or in addition to the gesture detection, a voice input device with voice detection and/or a physical input unit such as a keyboard or a touch screen may also be used.

As an alternative to the tester transmitting to identification and data processing unit 12 the information as to which vehicle is to be tested or to inputting the specifications of the motor vehicle, it is also possible for the motor vehicle 16 to be tested to be recognized automatically by image processing unit 10, which is operated using a suitable image detection software.

The information stored in the respective data records of the memory unit, which is transmitted by the identification and data processing unit to the display unit, may also include information about vehicle diagnostics, including a guided troubleshooting, information about installing and uninstalling vehicle components, particularly for repair, service instructions, instructions for training workshop personnel and emergency instructions, so-called rescue information.

1-10. (canceled)

11. An identification and test support device for identifying vehicle components and for supporting a motor vehicle test sequence, comprising:
an image signal receiver unit designed to receive an image signal from at least one image signal source, the image signal containing image data of at least one vehicle component;
an image processing unit designed to ascertain the type of the vehicle component from the image data of an image signal received by the image signal receiver unit;
a memory unit storing data records that include data records for a multitude of motor vehicle types, which contain, for a multitude of vehicle components, respectively relevant component information including at least one of: i) criteria to be met by the respective vehicle components, ii) possible weak points of the respective vehicle component, or iii) test steps to be performed for the vehicle component; and
an identification and data processing unit designed to assign the image data of the image signal received by the image signal receiver unit to the respectively associated data record of the memory unit, the identification and data processing unit being designed to check the image data of the image signal received by the image signal receiver unit for at least one of: i) adherence to the criteria stored in the associated data record and to transmit to a display unit the result of this check, ii) the possible weak points of the respective vehicle component contained in the associated data record, and iii) the test steps to be performed for the respective vehicle component contained in the associated data record.

12. The identification and test support device as recited in claim 11, further comprising:
at least one of: i) a pair of smart glasses include the image signal receiver unit and the display unit, ii) the image signal receiver unit being designed in the form of a permanently installed camera and the display unit being designed in the form of at least one permanently installed or portable screen.

13. The identification and test support device as recited in claim 11, further comprising:
at least one input device, the at least one input device being at least one of a touch screen, a voice input device, and a gesture detection device.

14. The identification and test support device as recited in claim 13, wherein a user is able to operate and control the identification and test support device via the input device.

15. The identification and test support device as recited in claim 13, wherein at least one of: i) a user is able to input an evaluation of the respective vehicle component via the input device, and ii) the identification and test support device is designed in such a way that it is possible to produce a test report on the basis of at least one evaluation submitted by a user via the input device.

16. The identification and test support device as recited in claim 15, further comprising:
a database that stores at least one of evaluations or test reports, submitted by a user via the input device.

17. The identification and test support device as recited in claim 13, wherein a user being able to input vehicle specifications including at least one of a make, a type, a year of manufacture and a vehicle code via the input device.

18. The identification and test support device as recited in claim 13, wherein the identification and test support device is designed so as to enable gesture detection in that the image signal receiver unit and the image processing unit are able to determine at least one position of at least one body part of a user and compare this to stored position patterns, and to select the specific stored position pattern that exhibits the greatest agreement with the at least one detected position and to perform the action associated with the position pattern thus determined.

19. The identification and test support device as recited in claim 11, which is furthermore designed in such a way that it is possible to ascertain from the image data of an image signal received by the image signal receiver unit, which contain at least one vehicle-identifying vehicle component or a total view of the vehicle, vehicle specifications including at least one of a make, a type, a year of manufacture and a vehicle code, by comparison with stored data records.

20. A method for identifying vehicle components and for supporting a motor vehicle test sequence, comprising:
receiving an image signal from at least one image signal source by an image signal receiver unit by a camera of a pair of smart glasses, the image signal containing image data of at least one vehicle component;
ascertaining a type of the vehicle component from the image data of the image signal received by the image signal receiver unit by an image processing unit;
assigning the image data of the image signal received by the image signal receiver unit to a respectively associated data record of a storage unit by an identification and data processing unit, data records being stored in the memory unit that include data records for a multitude of motor vehicle types, which contain for a multitude of vehicle components respectively relevant component information including at least one of: i) criteria to be met by the respective vehicle components, ii) possible weak points of the respective vehicle component, and iii) test steps to be performed for the vehicle component; and
checking the image data of the image signal received by the image signal receiving unit by the identification and data processing unit for at least one of: i) adherence to the criteria stored in the associated data record and, ii) the possible weak points of the respective vehicle component contained in the associated data record, and iii) the test steps to be performed for the respective vehicle components, which are contained in the associated data record, and transmitting a result of the checking to a display unit on the glasses of the pair of smart glasses.
